(19) United States
(12) Patent Application Publication
(10) Pub. No.: US 2008/0262914 A1
(43) Pub. Date: Oct. 23, 2008

(54) Ad Serving System, Apparatus and Methologies Used Therein

(76) Inventors: Ezra Suveyke, New York, NY (US); Bryon P. Evje, Chesterfield, NJ (US)

Correspondence Address: GORDON & JACOBSON, P.C., 60 LONG RIDGE ROAD, SUITE 407, STAMFORD, CT, 06902, US

(21) Appl. No.: 11/738,554

(22) Filed: Apr. 23, 2007

(51) Int. Cl. G06Q 30/00

(52) U.S. Cl. 705/14

(57) ABSTRACT

An ad serving system and methodology automatically monitors Publisher web content that can potentially be displayed alongside advertising content of one or more Advertiser Users. A web-accessible platform interacts with Advertiser Users to create and manage Ads, and cooperates with the content monitoring means to allow Advertiser Users to review the web content items that can potentially be displayed alongside the Ads and specify Ad Filter data corresponding to a particular Ad and one or more web content items. The Ad Filter data controls whether the particular Ad is excluded from accompanying the corresponding one or more web content items. The web-accessible platform also includes an interface between one or more Ad Server Engines and one or more data repositories storing the information generated by the platform. The interface retrieves relevant information from these repositories as part of the ad serving process carried out by the Ad Server Engine(s). The Ad Server Engine identifies Ad Filter data corresponding to requested web content and utilizes such Ad Filter data to exclude certain ads from an ad rotation as dictated by the corresponding Ad Filter data.

### BACKGROUND OF THE INVENTION

1. Field of the Invention

This invention relates broadly to systems for deploying advertisements over the World Wide Web. More particularly, this invention relates to methods and apparatus for serving banner and video advertisements over the World Wide Web.

2. State of the Art

An ad server is a tool used by ad agencies and/or clients to facilitate ad trafficking and to provide reporting on ad performance. The primary benefits of the ad server are threefold. First, rather than distribute copies of advertising content to publishers, agencies/clients can send code to publishers that calls up the creative content directly from the ad server each time an ad is scheduled to run. The agency loads the creative content to the ad server once and can modify rotations or add new units on the fly without needing to re-contact the publishers. Second, the ad server provides a wealth of data including impressions served, ads clicked, click-through rate (CTR) and cost-per-click (CPC). The ad server typically has the ability to provide performance against post-click activities such as sales, leads, downloads, or any other site based action the advertiser may want to measure. Furthermore, some ad servers can associate these post-click activities not only with site visitors who came via click, but also with site visitors who were exposed to the ads, but did not click. This is commonly known as view-through data. Third, the ad server provides a consistent counting methodology across the entire campaign enabling the agency to gain an “apples to apples” comparison of performance across the entire media schedule.

Publishing entities are supplied with an ad tag, which is code that is embedded in a web page. The ad tag embedded in the web page sends an “ad call” request to the ad server. The ad server receives the “ad call” request and selects advertising content based upon one or more targeting schemes, technical criteria and/or possibly other criteria, and then returns the selected advertising content (or a reference thereto) to the Internet user where it is rendered and displayed. The process of selecting advertising content in response to an “ad call” request and returning the selected advertising content (or reference thereto) is called ad rotation.

Current systems enable advertisers and clients to specify particular advertising content that is to be excluded from running with the web sites of particular publishers (or on particular channels of a given publisher). This is advantageous in that it affords advertisers and brand managers control over the web content that is viewed alongside their advertising content. However, it is inefficient and difficult to use because the advertisers and brand managers must manually review the web content that can potentially be displayed alongside their advertising content, which is an unmanageable task for dynamic sites and/or for large and diverse advertising campaigns.

### SUMMARY OF THE INVENTION

It is therefore an object of the invention to provide a system that manages the advertising content of advertisers and brand managers and that automatically monitors the web content that can potentially be displayed alongside such advertising content.

It is another object of the invention to provide such a system that enables the advertisers and brand managers to review the web content that can potentially be displayed alongside such advertising content and to specify that particular advertising content is to be excluded from accompanying particular publisher web content.

It is also an object of the present invention to provide advertisers and brand managers control over the web content that is viewed alongside their advertising content in a manner that is suitable for dynamic sites and/or for large and diverse advertising campaigns.

In accord with these objects, which will be discussed in detail below, an ad server system of the present invention includes a web-accessible platform that includes means for automatically monitoring Publisher web content items that can potentially be displayed alongside advertising content of one or more Advertiser Users.

The web-accessible platform also includes logic for presenting a graphical user interface to an Advertiser User that enables the Advertiser User to review a list of Campaigns of the Advertiser User and perform a variety of tasks related thereto. The graphical user interface also provides for real-time tracking and reporting of Campaigns as well as for individual Ads of the Advertising User.

The web-accessible platform also includes logic for presenting a graphical user interface to the Advertiser User that enables the Advertiser User to create and manage Campaigns of the Advertising User.

The web-accessible platform also includes logic for presenting a graphical user interface to the Advertiser User that enables the Advertiser User to create and managing one or more Outlets that are assigned to one or more Campaigns of the Advertiser User. An Outlet specifies one or more Publisher Web Site(s) as well as one ore more Categories.

The web-accessible platform also includes logic for presenting a graphical user interface to the Advertiser User that enables the Advertiser User to create and manage one or more Ad Rotations for the Advertiser User. An Ad Rotation assigns one or more Ads of the Advertiser User to one or more Outlets.

The web-accessible platform also includes logic for presenting a graphical user interface to the Advertiser User that enables the Advertiser User to review the web content that can potentially be displayed alongside the Ads of the Advertiser User and specify Ad Filter data corresponding to a particular Ad and one or more web content items. The Ad Filter data controls whether the particular Ad is excluded from accompanying the corresponding one or more web content items in the ad serving process. The Ad Filter data preferably allows the Advertiser User to include or exclude a particular digital content item or a group of digital content items from accompanying a particular Ad.

The web-accessible platform also includes an interface between one or more Ad Server Engines and one or more data repositories storing the information generated by the platform. The interface retrieves relevant information from these repositories as part of the ad serving process carried out by the Ad Server Engine(s). The Ad Server Engine identifies Ad Filter data corresponding to requested web content and utilizes such Ad Filter data to exclude certain Ads from an ad rotation as dictated by the corresponding Ad Filter data.

It will be appreciated that the ad serving system and corresponding methodology of the present invention provides for automatic monitoring of the web content that can potentially be displayed alongside advertising content, and enables advertisers and brand managers to select and review one or more web content items that can accompany an advertisement as well as create ad filter data corresponding to such web content items if desired. The ad filter data provides brand security to the advertiser/brand manager by enabling control over the ad serving process with respect to digital content items of a Publisher's web site(s) preferably on a group basis and an individual basis.

Additional objects and advantages of the invention will become apparent to those skilled in the art upon reference to the detailed description taken in conjunction with the provided figures.

### BRIEF DESCRIPTION OF THE DRAWINGS

FIG. 1 is a functional block diagram of the architecture of an illustrative ad serving system in accordance with the present invention.

FIG. 2 is a schematic illustration of an illustrative ad serving process carried out in conjunction with the ad serving system of FIG. 1.

FIG. 3 is a schematic illustration of an exemplary hierarchical set of Categories.

FIG. 4A is an exemplary graphical user interface generated by the web-accessible platform of FIG. 1, the graphical user interface presenting to the Advertiser User a list of Campaigns and the metrics and results related thereto.

FIG. 4B is an exemplary graphical user interface generated by the web-accessible platform of FIG. 1, the graphical user interface enabling the Advertiser User to create a Campaign.

FIG. 4C is an exemplary graphical user interface generated by the web-accessible platform of FIG. 1, the graphical user interface enabling the Advertiser User to create and manage Outlets.

FIGS. 4D and 4E are exemplary graphical user interfaces generated by the web-accessible platform of FIG. 1, the graphical user interfaces enabling the Advertiser User to create and manage Ad Rotations; the graphical user interfaces also present to the Advertiser User the metrics and results related to individual Ads.

FIG. 4F is an exemplary graphical user interface generated by the web-accessible platform of FIG. 1, the graphical user interface enabling the Advertiser User to select and review web content item(s) as well as specify an Ad Filter pertaining to a particular Ad and one or more of such web content items.

FIGS. 5A and 5B are schematic illustrations of an exemplary folder structure and xml file schema, respectively, for storing the Ad Filter data generated by the web-accessible platform of FIG. 1.

FIG. 6 is an exemplary xml schema for storing advertising information generated by the web-accessible platform of FIG. 1.

FIG. 7 is a flowchart illustrating operations carried out by the web-accessible platform of FIG. 1 for automatically capturing screen shots of ads for audit purposes (and possibly other verification purposes).

### DETAILED DESCRIPTION

As used herein, the term “Ad” or “Ads” means digital content that carries information for advertising, promoting or otherwise conveying information about products or services of a commercial entity or a government entity or other entity. Ads can include a banner-type advertisement, a gateway-type advertisement, an interstitial-type advertisement, a bumper-type advertisement and other suitable forms of information. A banner-type advertisement embeds an advertisement into a web page. It is intended to attract traffic to a website by linking them to the web site of the advertiser. The advertisement is constructed from an image (GIF, JPEG, PNG), JavaScript program or multimedia object employing technologies such as Java, Shockwave or Flash, often employing animation or sound to maximize presence. Images are usually in a high-aspect ratio shape (i.e. either wide and short, or tall and narrow) hence the reference to banners. A gateway-type advertisement is played before program content. Gateway-type advertisements are often popular on news web sites where a short clip or promo might play prior to video program content. Interstitial-type advertisements are played between program entries in a playlist. For example, on a news web site, interstitial advertisements can be inserted between top news stories. A bumper-type advertisement is appended to the end of program content.

As used herein, the term “User” means an operator or application that accesses the Ad Serving Platform of the present invention under a certain type.

As used herein, the “Advertiser User” is a User who owns and/or controls and/or manages Ads, and wants the Ads to be displayed on Publisher Web Sites. Advertiser Users create and manage Campaigns in the Ad Serving Platform of the present invention. There can be one or more Advertiser Users that can access and/or manage a given Campaign (or a given group of Campaigns). Advertising Users can be one or more authorized users of ad agencies, brand management entities, publishers or other operators wishing to deploy Ads.

As used herein, “Publisher” means an entity who owns and/or controls and/or manages one or more web sites (which are referred to herein as Publisher Web Sites), and wants Ads to be displayed on such Publisher Web Site(s).

As used herein, an “Ad Tag” means code that is embedded in web content. The embedded Ad Tag is used to generate and send an Ad Call request to the Ad Serving Platform of the present invention. As described below in more detail, the Ad Call request includes an identifier (e.g., URL) for the source web content (i.e., the web content with the Ad Tag embedded therein). The Ad Call request is received by the Ad Serving Platform of the present invention and processed to select advertising content based upon selection criteria as described herein. The Ad Serving Platform returns to the requester a reference to the selected advertising content, where it is used to retrieve the selected advertisement from one or more content sources, and then rendered/played in a designated manner accompanying the requested source web content. Alternatively, the Ad Serving Platform can fetch the selected advertising content from the one or more content sources and supply the selected advertising content to the requester for rendering/playback in a designated manner accompanying the requested source web content.

As used herein, the term “Campaign” means a collection of information relating to the needs of an Advertiser User, the information including advertising content represented by one or more Ads and possibly other information such as start and end dates, targeting criteria that relates to a designated group of Internet users, and costs (e.g., Cost Per Click (CPC), Cost Per Impression (CPM), Cost Per Action (CPA), Cost Per Lead (CPL)).

As used herein, the term “Categories” means contextual areas that are typical across Publishers' Web Sites and can be hierarchical in nature.

As used herein, the term “Outlet” means data specifying one or more Publisher Web Site(s) as well as one or more Categories. An Outlet is designated by an Advertiser User. An Outlet is assigned to a Campaign to specify the Publisher Web Site(s) and Category(ies) therein that can be targeted by the advertising content of the Campaign.

As used herein, the term “Ad Rotation” means data assigning one or more Ads to one or more Outlets. As Outlets are assigned to Campaigns, the Ad Rotation specifies the advertising content assigned to Campaigns of Advertiser Users.

As used herein, the term “Ad Filter” means data associated with a particular Ad of an Advertiser User and one or more particular digital content items of a Publisher Web Site. The Ad Filter specifies whether or not the particular Ad can accompany the particular digital content item. The Ad Filter is associated with a particular Ad of an Advertiser User and one or more of such digital content items. The Ad Filter data preferably specifies whether or not the particular Ad can accompany the associated digital content items on a group basis and an individual basis. The Ad Filter is specified by the Advertiser User.

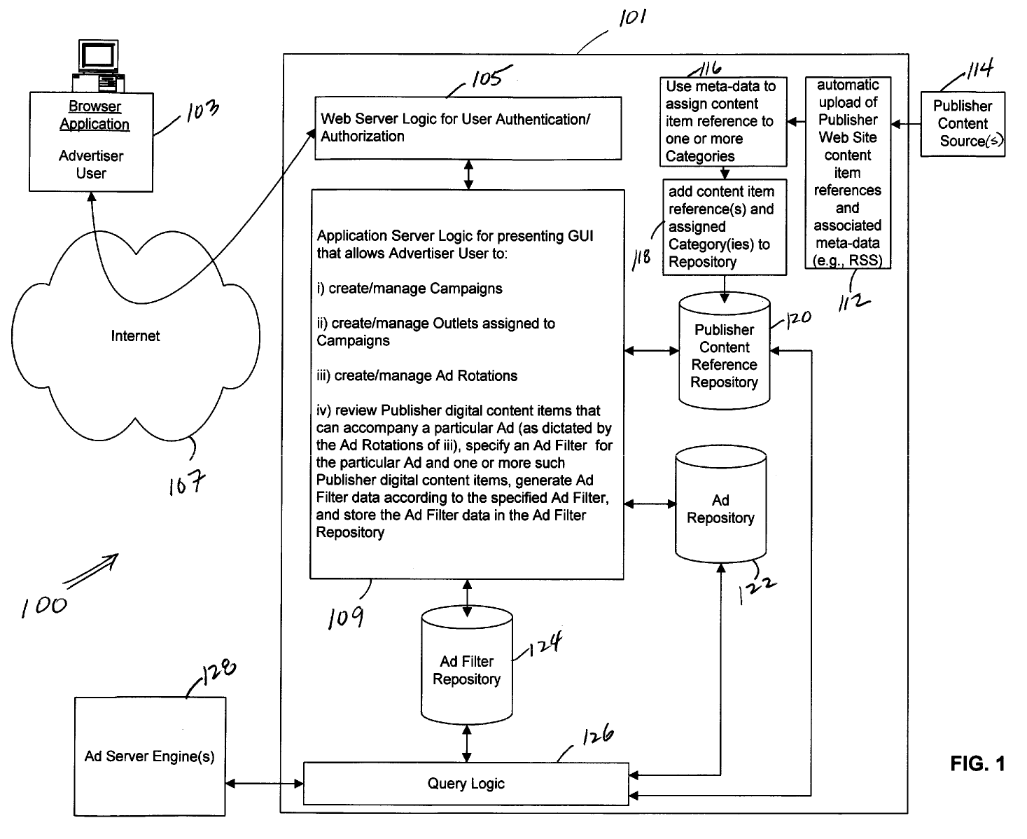

Turning now to FIG. 1, there is shown the architecture of an ad serving system 100 in accordance with the present invention. An Advertiser User accesses a services platform 101 utilizing a web browser application environment executing on a computing device 103 to connect to a web server 105 over the network 107 (e.g., Internet). Preferably, the browser-based interaction between the computing device 103 and the web server 105 occurs over one or more TCP/IP sessions established therebetween.

The web server 105 enables login and authentication of the Advertiser User via interaction with the system 103. Such login and authentication can utilize password-based authentication, operating system-based authentication (e.g., NTLM or Kerberos); services-based authentication (e.g., Microsoft Passport authentication), certificate-based authentication, or any other authentication scheme. Once a user session has been authorized, the web server 105 communicates with an Application Server 109 to build dynamic web page(s) based on data supplied by the Application Server 109, serve the dynamic web page(s) to the Advertiser User web browser application environment, and forward data supplied by the Advertiser User web browser application environment to the Application Server 109 as needed. The web server 105 may be realized by any commercially available HTTP server.

The Application Server 109 includes logic for presenting a graphical user interface to the Advertiser User that enables the Advertiser User to review a list of Campaigns of the Advertiser User and perform a variety of tasks related thereto as described below in more detail. Preferably, the Application Server 109 employs a commercially-available software framework, such as the WebLogic Platform commercially available from BEA Systems of San Jose, Calif., the Websphere Application Server commercially available from IBM, Windows Server Systems commercially available from Microsoft Corporation of Redmond, Wash., the SUN Java System Application Server commercially available from Sun Microsystems of Santa Clara, Calif., or the Oracle Application Server commercially available from Oracle Corporation of Redwood Shores, Calif.

The service platform 101 includes a block 112 that access data from one or more Publisher content sources 14 as shown. The accessed data includes the following:
i) one or more URL(s) that refer to targetable digital content items (preferably used for gateway-type, interstitial-type and bumper-type video ads) and/or targetable advertising space (preferably used for banner advertisements) across a given Publisher's web site; and
ii) meta-data associated with each URL in i), the meta-data representing subject descriptors for the targetable digital content item and/or targetable advertising space referenced by the associated URL, a title for the digital content item referenced by the associated URL, and possibly a thumbnail image for the digital content item referenced by the associated URL.
   Preferably, the accessed data is packaged in an xml file or other suitable data structure and is accessed automatically via an RSS feed, an XML feed, structured messaging or other suitable mechanism. The subject descriptors of the meta-data preferably utilize the name space of the Categories of the platform 101. Alternatively, the subject descriptors can utilize a different name space.

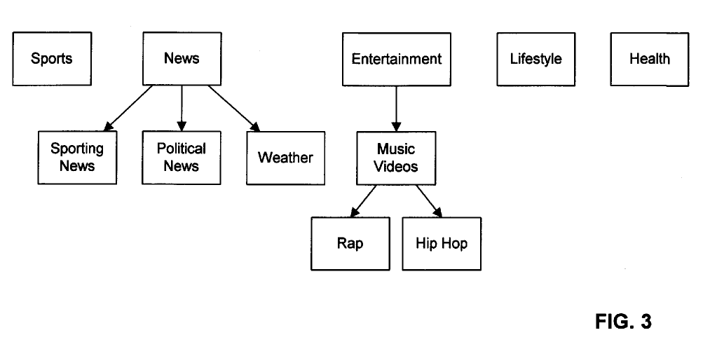

Block 116 of the platform 101 processes the data accessed in block 112 to assign one or more Categories to each given URL based upon the meta-data associated with the given URL. The Category assignment processing can be accomplished in many different ways depending on the name space of the subject descriptors of the meta-data and the name space of the Categories of platform 101 and the relationships therebetween. In the event that the subject descriptors and the Categories utilize the same name space, the assignment can be carried out by a simple one-to-one mapping operation. If the subject descriptors and the Categories utilize different name spaces, a more complex mapping operation (such as a rule-based mapping function) is required. As defined above, the Categories of the platform 101 represent contextual areas that are typical across Publishers' Web Sites and preferably are hierarchical in nature as depicted in the example of FIG. 3.

Block 118 adds to database 120 (labeled “Publisher Content Reference Repository) the URL(s) of the accessed data, the identifiers for each Category assigned to each given URL in block 116, the title for the digital content item referenced by each given URL (from the meta-data of the uploaded data), and the thumbnail image of the digital content item referenced by each given URL, if any (from the meta-data of the uploaded data). As described below in more detail, the data stored in the Publisher Content Reference repository 120 enables Advertiser Users of the platform 101 to select and review one or more digital content items that can accompany an Ad as dictated by Ad Rotations managed and controlled by the platform 101, and then create Ad Filter data corresponding thereto if desired. The review process enables the Advertiser User to screen the digital content item(s) hat can accompany an Ad as dictated by Ad Rotations managed and controlled by the platform 101. The Ad Filter data provides brand security to the Advertiser User by enabling control over the ad serving process with respect to digital content items of a Publisher's Web Site(s) preferably on a group basis and an individual basis as described below in more detail.

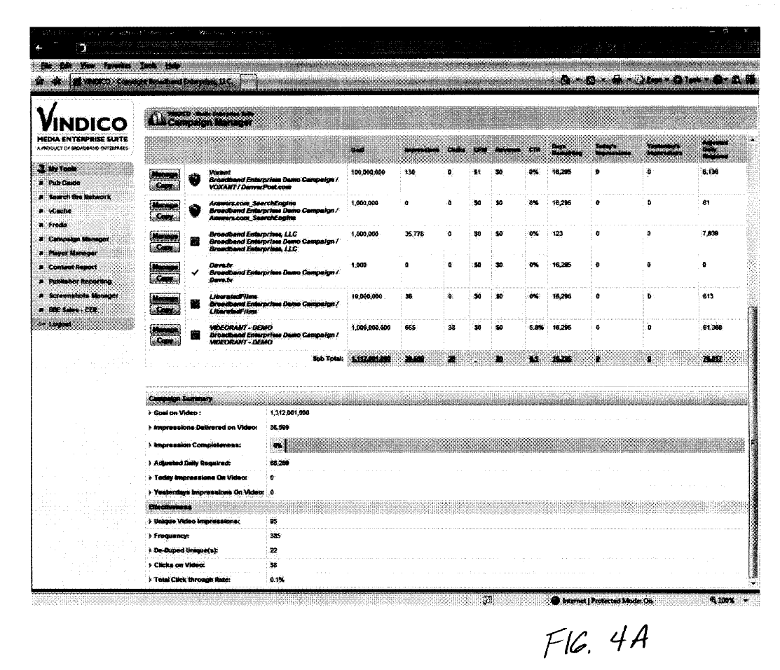

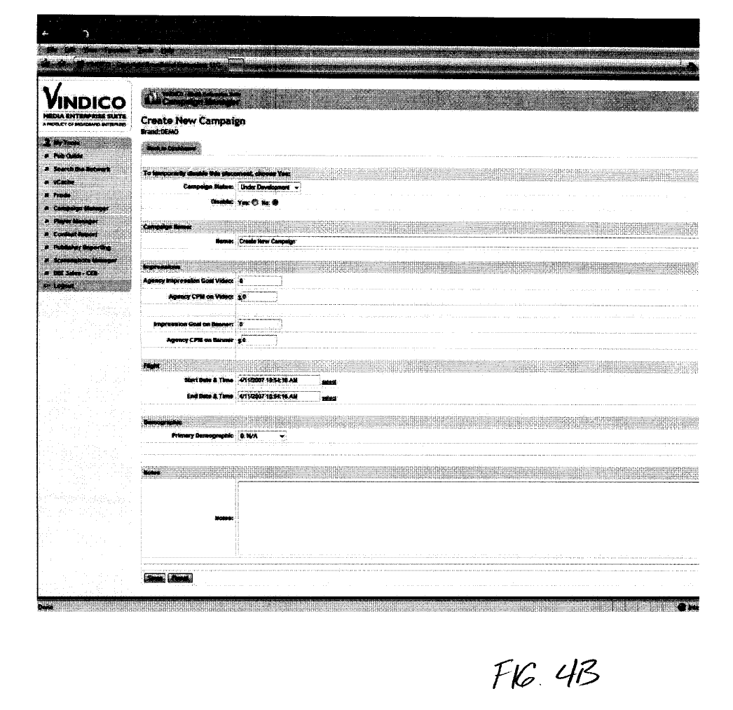

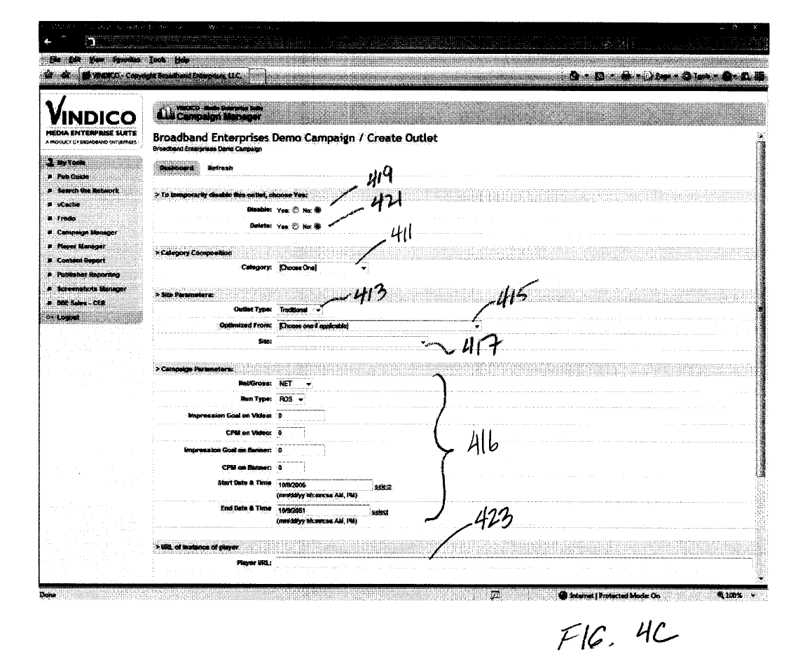

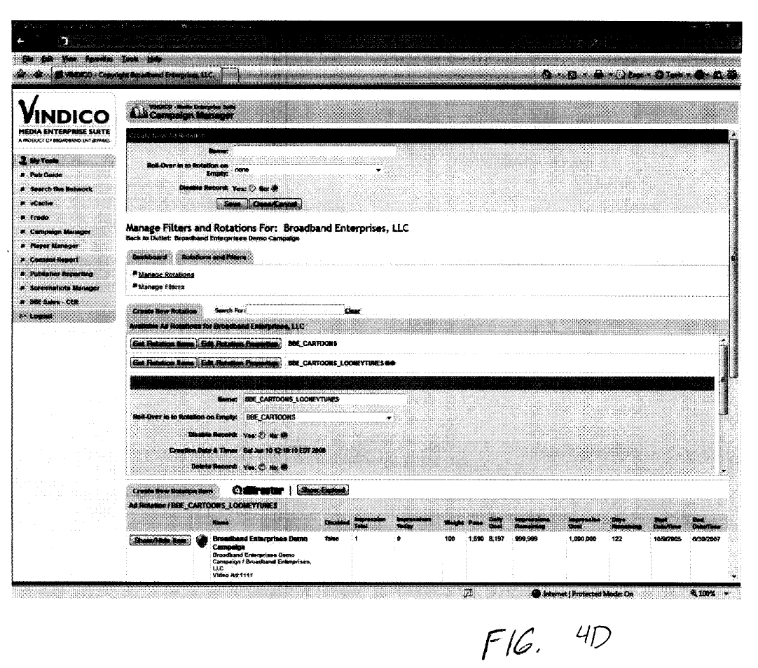

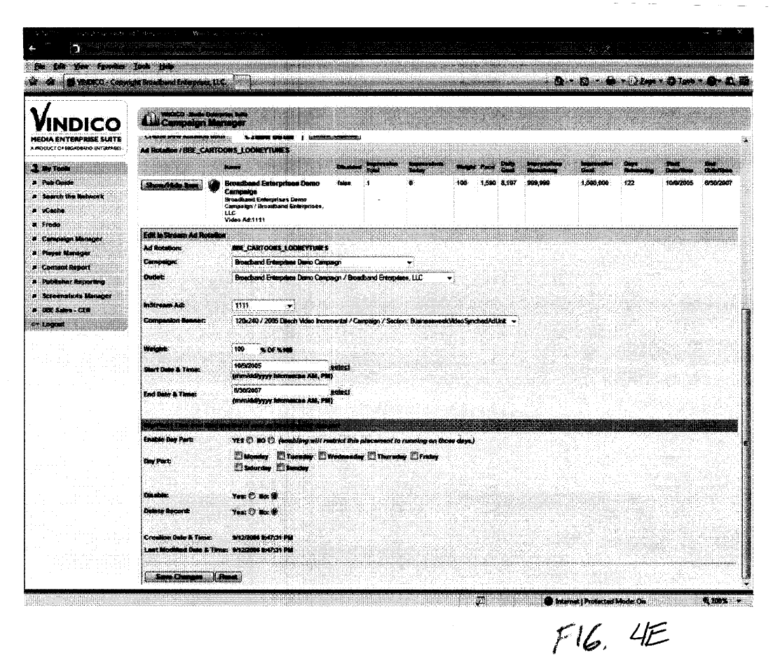

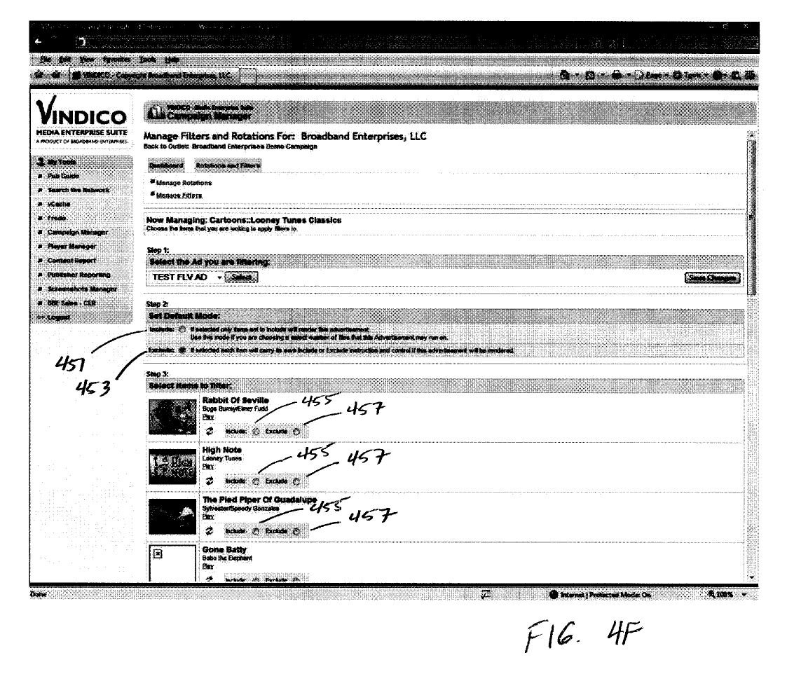

The Application Server 109 includes logic for presenting a graphical user interface to the Advertiser User that enables the Advertiser User to review a list of Campaigns of the Advertiser User and perform a variety of tasks related thereto. The graphical user interface also cooperates with an ad-tracking module (not shown) that records key metrics such as, for example, impressions, reach, user interaction and time spent. The ad-tracking module collects tracking data in real time and formats the results in real-time such the results are accessible by the Advertising User in real-time on the graphical user interface. The results are preferably presented to the Advertising User for Campaigns as well as for individual Ads of the Advertising User. An exemplary graphical user interface that presents a list of Campaigns and the metrics and results related thereto is shown in FIG. 4A. An exemplary graphical user interface that presents the results related to an individual Ad is shown in FIGS. 4D and 4E.

One of the tasks (labeled “i)” in FIG. 1) supported by the Application Server 109 includes creating and managing Campaigns of the Advertising User, which preferably enables the Advertiser User to specify and update the name of a Campaign, the start date and the end date of the Campaign, a targeted demographic, parametric goals for the Campaign (e.g., impression goal for video advertisements, impression goal for banner advertisements, cost per impression (CPM) for video advertisements, cost per impression (CPM) for banner advertisements, cost per click (CPC) for video advertisements, cost per click (CPC) for banner advertisements, cost per action (CPA) for video advertisements, cost per action (CPA) for banner advertisements, cost per lead (CPL) for video advertisements, cost per lead (CPL) for banner advertisements). The information of the Campaign(s) of the Advertising User is stored in a database 122 (labeled “Ad Repository”). An exemplary user interface for creating and managing a Campaign is shown in FIG. 4B.

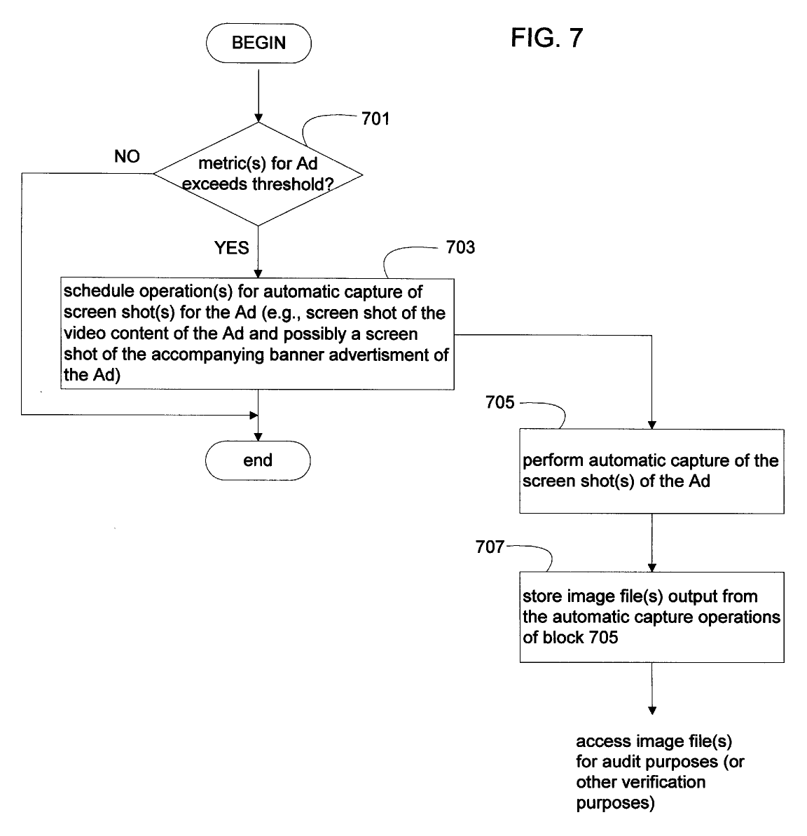

Another task (labeled “ii)” in FIG. 1) supported by the Application Server 109 includes creating and managing one or more Outlets that are assigned to one or more Campaigns of the Advertiser User. As defined above, an Outlet specifies one or more Publisher Web Site(s) as well as one ore more Categories. The Outlet is designated by the Advertiser User. The information of the Outlet(s) for the Advertising User is stored in the Ad Repository 22. An exemplary user interface for creating and managing an Outlet is shown in FIG. 4C. This interface includes a widget 411 (which is preferably realized by a drop-down or pull-down menu) that enables the Advertiser User to specify a Category for the Outlet, a widget 413 (which is preferably realized by a drop-down or pull-down menu) that enables the Advertiser User to specify an Outlet type for the Outlet (which is preferably used to control output report methodology), a widget 415 (which is preferably realized by a drop-down or pull-down menu) that enables the Advertiser User to specify an “Optimized from” parameter for the Outlet (which is preferably used to tag the Outlet for billing purposes), and a widget 417 (which is preferably realized by a drop-down or pull-down menu) that enables the Advertiser User to specify a URL for the Publisher Web Site of the Outlet. A machine-generated name is associated with Outlet when saved, which can be updated by user input. The interface also includes a set of widgets 416 for specifying a start date and an end date for the Outlet as well as parametric goals for the Outlet (e.g., impression goal for video advertisements, impression goal for banner advertisements, cost per impression (CPM) for video advertisements, cost per impression (CPM) for banner advertisements, cost per click (CPC) for video advertisements, cost per click (CPC) for banner advertisements, cost per action (CPA) for video advertisements, cost per action (CPA) for banner advertisements, cost per lead (CPL) for video advertisements, cost per lead (CPL) for banner advertisements). The user interface also includes a widget 419 (preferably realized by Yes and No buttons) that enable the Advertiser User to disable the Outlet, and a widget 421 (preferably realized by Yes and No buttons) that enable the Advertiser User to delete the Outlet. The interface also includes a widget 423 (e.g., text input field) that enables the Advertiser User to specify a URL to an object for playing/rendering Ads of the Outlet. The URL specified by widget 423 can be used to automatically capture screen shots of Ads of the Outlet for audit purposes (or possibly other verification purposes) as described below with respect to FIG. 7.

Another task (labeled “iii) in FIG. 1) supported by the Application Server 109 is the creation and management of one or more Ad Rotations for the Advertiser User. An Ad Rotation assigns one or more Ads of the Advertiser User to one or more Outlets. An Ad Rotation preferably includes the following:
a Name for the Ad Rotation (e.g., BBE_CARTOONS_LOONEYTUNES);
a Name of a Parent Ad Rotation to rollover to during serving if this Ad Rotation is empty (which is described below in more detail);
the Outlet and corresponding Campaign to which the Ad Rotation is assigned;
a collection of Rotation Items for the Advertiser User. A Rotation Item specifies one or more Ads of the Advertiser User (e.g., an identifier for a video Ad and/or possibly an identifier for a companion banner Ad) as well as item specific properties (such as a start date, an end date, days of week restrictions, time of day restrictions, and a weight used in serving Ads that compete as part of the associated Campaign).
   The management of a given Ad Rotation preferably allows for disabling and deleting the given Ad Rotation. The management of a given Rotation Item preferably allows for disabling and deleting the given Ad Rotation Item, updating the Campaign and Outlet to which a given Ad Rotation Item is assigned, and updating the Ad Rotation Item including the update of the item specific properties associated therewith. The information of the Ad Rotation(s) for the Advertising User is stored in the Ad Repository 122. The advertising content of the Ads can be stored locally in the Ad repository 122 or possibly referenced by a URL or other identifier to a remote Ad content source (e.g., a database of Ad content or a distribution network of Ad content). An exemplary user interface for creating and managing Ad Rotations is shown in FIGS. 4D and 4E.

Another task (labeled “iv)” in FIG. 1) supported by the Application Server 109 is the selection and review of the digital content item(s) that can potentially accompany a user-specified Ad as part of an Ad Rotation of the Advertiser User as well as the specification of an Ad Filter for one or more of such digital content items as desired. In the preferred embodiment, the Advertiser User specifies an Outlet as well as a Category associated therewith, and then selects a particular Ad preferably from a drop-down list or pull down list of Ads associated with the specified Outlet and Category. This list is generated from the information stored in the Ad Repository 122. The Application Server 109 utilizes the URL of the Publisher Web Site of the specified Outlet and the specified Category to retrieve from the Publisher Content Reference Repository 120 the digital content item references stored therein that satisfy two conditions as follows:
i) the digital content item reference is part of the Publisher Web Site(s) of the Outlet; and
ii) the digital content item reference has a Category assigned thereto that matches the specified Category.

The Application Server 109 also retrieves from the Publisher Content Reference Repository 20 the title and thumbnail (if any) associated with each given matching digital content item. The Application Server then presents a GUI allowing the Advertiser User to access and review (e.g. view or play) such digital content items and specify Ad Filter data for one or more of such digital content items if desired. When selected for view/playback, the Application Server 109 uses the URL reference(s) of the matching digital content item(s) to retrieve such item(s) from the appropriate Publisher Content Source 114. Alternatively, the URL reference(s) of the matching digital content item(s) can be used to prefetch such item(s) from the appropriate Publisher Content Source 114 prior to user selection of viewing/playback. The GUI preferably presents the digital content items in a list form, including the title and the thumbnail (if available) of each digital content item as well as a view/play widget associated therewith. The Ad Filter preferably specifies whether or not the particular Ad can accompany the associated digital content items on a group basis or on an individual basis. The Application Server 109 generates and stores in a database 124 (labeled “Ad Filter Repository”) Ad Filter data corresponding to the Ad Filter input specified by the Adverting User. An exemplary user interface for selection and review of digital content item(s) as well as the specification of an Ad Filter for one or more of such digital content items is shown in FIG. 4F. In the preferred embodiment, the Ad Filter input specified by the Advertiser User includes the following information:
a default IncludeExclude mode value (preferably realized by an Include button 451 and an Exclude button 453) that is associated with one or more digital content items. The default IncludeExlude mode value indicates the default state of whether or not the particular Ad can accompany the digital content item(s) associated therewith. This default state governs the digital content item(s) associated therewith on a group basis, but can be overridden by the Advertiser User specifying otherwise by setting the item-specific IncludeExclude mode value for a given digital content item. In this manner, the item-specific IncludeExclude mode value governs a particular digital content item on an individual basis.
an item-specific includeExclude mode value (preferably realized by an Include button 455 and an Exclude button 457) that is associated with a particular digital content item. The item-specific IncludeExclude mode value represents whether or not the particular Ad can accompany the particular digital content item.
   In this manner, the Ad Filter allows the Advertiser User to include or exclude a particular digital content item or a group of digital content items from accompanying a particular Ad.

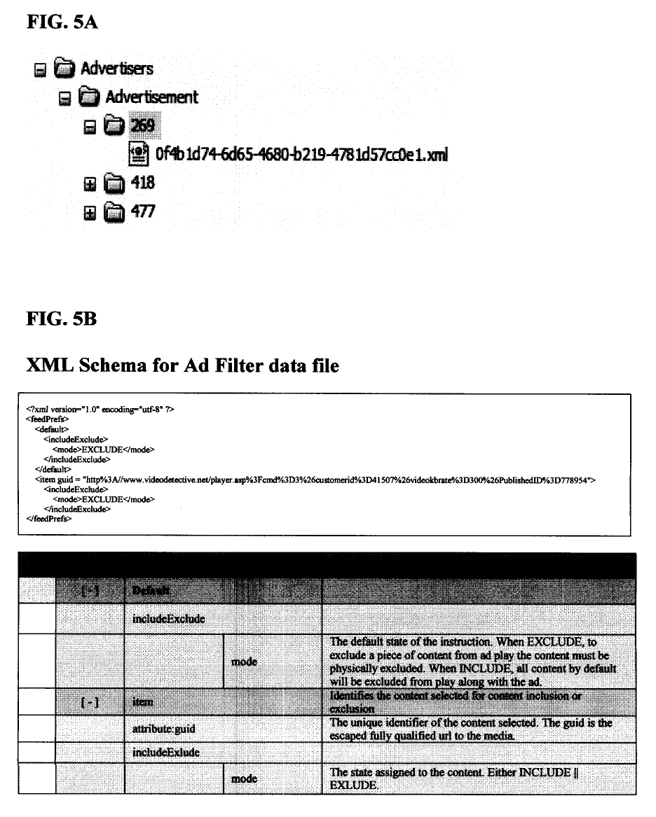

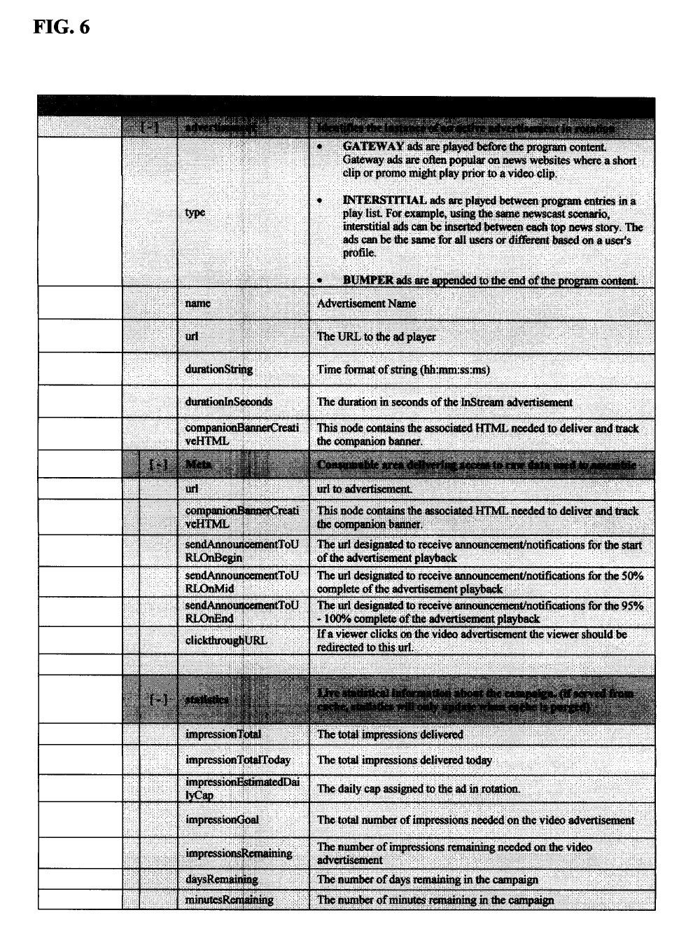

In the preferred embodiment, the Ad Filter data generated by the Application Server 109 and stored in the Ad Filter Repository 124 is realized by xml data files stored in a directory folder structure as shown in FIGS. 5A and 5B. The names of the folders correspond to Ad IDs uniquely assigned to Ads. Each folder stores an xml data file for the particular Ad associated therewith. For example, the folder “269” stores an xml data file for the Ad named “AMEX OSBN 2006—Arts and Leisure Campaign”, which is assigned Ad ID 269. The xml data file includes the following information:
a default IncludeExclude mode value that is associated with the one or more digital content items that follow in the xml data file. The default IncludeExlude mode value indicates the default state of whether or not the particular Ad (ID 269 for “AMEX OSBN 2006—Arts and Leisure Campaign”) can accompany the digital content item(s) associated therewith. This default state governs the digital content item(s) associated therewith on a group basis as described above.
a pair of data values for each particular digital content item associated with the particular Ad ID including
   i) the URL for particular digital content item
   ii) an item-specific IncludeExclude mode value that represents
whether or not the particular Ad (ID 269 for “AMEX OSBN 2006—Arts and Leisure Campaign”) can accompany the particular digital content item (identified by its URL). The item-specific IncludeExclude mode value governs a particular digital content item on an individual basis as described above.

In the preferred embodiment, the Ad Repository 122 of the platform 101 stores information associated with a particular Ad, which preferably includes the URL to the content of the Ad as well as meta-data related to the Ad (such as ad type, advertisement name, a URL to a player for playing the advertisement, the duration of the advertisement, HTML for delivering and tracking a companion banner, tracking information (e.g., one or more URLs to receive notifications related to advertisement playback, clickthrough URL), and parameters and statistical information related to the Ad for targeting and reporting purposes (e.g., total impressions delivered, total impressions delivered today, daily cap, total number of impressions needed, remaining number of impressions needed, number of days remaining in campaign, number of minutes remaining in campaign). Such information is preferably realized by an xml data file with a schema as shown in FIG. 6.

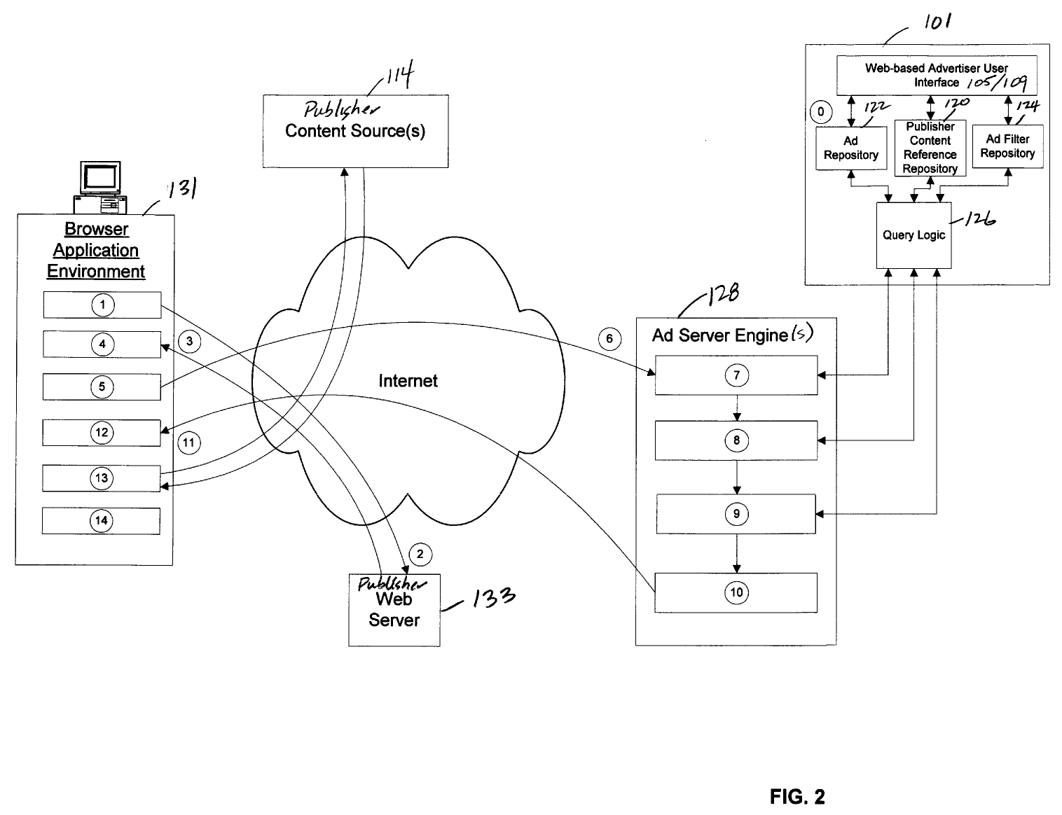

The platform 101 also includes query logic 126 that provides an interface between one or more Ad Server Engines 128 and the Publisher Content Reference Repository 120, the Ad Repository 122 and the Ad Filter Repository 124. The query logic 126 is used to retrieve relevant information from these repositories as part of the ad serving process (FIG. 2) carried out by the Ad Server Engine(s) 128.

The system 100 of FIG. 1 is used as part of an ad serving process shown in FIG. 2. The process begins in step 0 where the platform 101 stores Ad information in the Ad Repository 122, Publisher content reference information in the Publisher Content Reference Repository 120 and Ad Filter information in the Ad Filter repository 124 as described above. In step 1, an individual operates a browser application environment 131 to request web content from a Publisher web server 133. In step 2, the request is communicated to the Publisher web server 133 over the Internet. In step 3, the Publisher web server 133 returns the requested web content over the Internet. The requested web content that is returned by the Publisher web server 133 has an Ad Tag embedded therein.

In step 4, the browser application environment 133 receives the requested web content. In step 5, the browser application environment 133 processes the Ad Tag embedded in the requested web content and redirects to the Ad Server Engine 128 by issuing an Ad Call request to the Ad Server Engine 128. The Ad Call request includes the URL for the requested web content received in step 4 as well as meta-data related thereto, which can include one or more subject descriptors (for contextual targeting), behavioral information (for behavioral targeting), and/or geographic information (for geographic targeting).

In step 6, the Ad Call request is communicated to the Ad Server Engine 128 over the Internet. In step 7, the Ad Server Engine 128 receives the Ad Call request and generates a candidate list identifying one or more Ads that can potentially be used to fulfill the Ad Call request. The Ad Server Engine 128 generates the candidate list by cooperating with the Query Logic 126 of platform 101 to:
i) retrieve from the Publisher Content Reference Repository 120 the one or more Categories assigned to requested web content (which is carried out in block 116 of FIG. 1. as described above), if any; the URL of the requested web content is used to identify Category information stored in the Publisher Content Reference Repository 120 that is associated therewith;
ii) if there is no Category information assigned to the requested web content as stored in the Publisher Content Reference Repository 120, assign one or more Categories to the requested web content based upon the meta-data of the Ad Call request; such Category assignment operations can be similar to those carried out by block 116; and
iii) retrieve from the Ad Repository 122 of platform 101 the identification information for those Ads that are assigned to an Ad Rotation whose Outlet (Publisher Web Site(s)/Category(ies)) correspond to the URL and the Category(ies) of the requested web content as identified in i) or ii).
   Geographical, contextual and/or behavioral targeting criteria can be used to narrow the initial candidate list as is well known. If the initial candidate list is empty, the Query Logic 126 can retrieve from the Ad Repository 122 identification information for those Ads that are assigned to parent Ad Rotations whose Outlet (Publisher Web Site(s)/Category(ies)) correspond to the URL and the Category(ies) of the requested web content as identified in i) or ii), and return such identification information to the Ad Server Engine 128 for building the initial candidate list. The parent Ad Rotations are defined by links specified in the Ad Rotations as described above.

In step 8, the Ad Server Engine 128 cooperates with the Query Logic 126 to retrieve from the Ad Filter Repository 124 the Ad Filter data that pertains to the Ads of the candidate list. The Ad Server Engine then utilizes such Ad Filter data to determine which Ads (if any) should be removed from the candidate list as dictated by a corresponding Ad Filter. This processing preferably includes the following substeps. The Ad Serve Engine 128 sequences through the Ad(s) in the candidate list. For each given Ad in the sequence, the Ad Server Engine 128 identifies all Ad Filter data that pertains to the given Ad (e.g., the Ad ID for the given Ad is stored as part of the Ad Filter data). The identified Ad Filter data is processed to identify the particular Ad Filter data that refers to the source web content identified in the Ad Call request (e.g., the URL of the source web content refers to the URL of the particular digital content item as stored in the Ad Filter data). This particular Ad Filter data is analyzed to determine if the Ad Filter data indicates that the given Ad should not accompany the source web content. If so, the given Ad is removed from the candidate list. If not, the given Ad remains on the candidate list.

In step 9, in the event that the candidate list generated in step 8 has more than one Ad, the Ad Server Engine 128 applies one or more filtering operations to the candidate list to select one of the Ads in the candidate list. Such filtering operations can be based upon weights (i.e., weights pertaining to ads that compete as part of a campaign), daily impression cap coverage, start date/end date, and impressions remaining, all of which can be retrieved from the Ad Repository 122 of platform 101 by cooperation with the Query Logic 126 or other suitable mechanism. The URL(s) of the selected Ad is also retrieved from the Ad Repository 122 by cooperation with the Query Logic 122.

In step 10, the Ad Server Engine 128 returns the URL of the selected Ad retrieved in step 9. In step 11, the URL(s) of the selected Ad is communicated from the Ad Server Engine 118 to the browser application environment 103 over the Internet. In step 12, the browser application environment 103 receives the URL(s) of the selected Ad. In step 13, the browser application environment 103 uses the received URL(s) of the selected Ad to cooperate with the Publisher Content Source(s) 114 to return the selected Ad. In step 14, the browser application environment 103 displays or plays the selected Ad in conjunction with the web content returned in step 3.

The Ad Server Engine 128 can possibly prefetch one or more Ads during the filtering processes of step 8 and/or step 9 and communicate the Ad to the browser application environment 103 (instead of requiring the browser application environment 103 to retrieve the Ad from one or more Publisher Content Source(s) 114).

Advantageously, the ad serving system and corresponding methodology of the present invention enables advertisers and/or brand managers to select and review one or more digital content items that can accompany an advertisement, and then create ad filter data corresponding thereto if desired. The ad filter data provides brand security to the advertiser/brand manager by enabling control over the ad serving process with respect to digital content items of a Publisher's web site(s) on a group basis and an individual basis.

In another aspect of the present invention, publishers and advertisers commonly perform audit functions for verifying consistent and accurate online advertising measurements across the publishers and ad serving technologies. Such audit functions commonly involve manually accessing a given publisher's web site to verify that particular advertising content is accessible from the web site. Such manual access operations are time intensive and prone to error.

FIG. 7 illustrates operations carried out by the web-accessible platform 101 of FIG. 1 that automatically captures screen shots of Ads that are accessible from Publishers' web sites for audit purposes (and possibly other verification purposes). Such automatic screen capture operations are more efficient and accurate than the manual operations of the prior art.

The operations of FIG. 7 employ a decision block 701 that scans the Ads maintained by the platform 101 (which are preferably stored in the Ad repository 122 as described above) and checks whether one or more metrics for each given Ad exceed a predetermined threshold level. The metric can be based on the number of impressions for the Ad, the number of days run or hours run for the Ad, or other predefined metric. The scanning can be performed continuously, on a periodic basis (for example, every hour or every day), or on-demand. In the event that the metric(s) for a given Ad exceed the predetermined threshold level, the operations continue to block 703.

Block 73 schedules operations for automatic capture of one or more screen shots for the given Ad. For example, where the given Ad includes both video content and an accompanying banner advertisement, block 703 preferably schedules the automatic capture of a screen shot of the video content as well as the automatic capture of a screen shot of the banner advertisement of the Ad.

In block 705, the automatic screen shot capture operations scheduled by block 703 are performed. Such operations preferably utilize the URL specified by widget 423 of FIG. 4C to play/render the Ad for automatic capture. In some instances, the automatic capture process can result in a black screen due to internet latency or unsupported refresh rate. In these instances, a URL to the specific content of the Ad (which is preferably stored and retrieved from the Ad repository 122 of FIG. 1) can be used to access the specific content of the Ad and then played/rendered for automatic capture.

In block 707, image file(s) output from the automatic screen shot capture operations of block 707 are stored. Each image file includes (or is associated with) data that represents the data and time that the image file was created. The stored image files can be accessed as needed for audit purposes (or possibly other verification purposes).

There have been described and illustrated herein several embodiments of an Ad Serving System and corresponding method of operation. While particular embodiments of the invention have been described, it is not intended that the invention be limited thereto, as it is intended that the invention be as broad in scope as the art will allow and that the specification be read likewise. Thus, while particular functional blocks have been disclosed, it will be appreciated that such functional blocks can be integrated together or partitioned apart as well. In addition, while particular types of data structures have been disclosed, it will be understood that other data structures can be used. Also, while a preferred ad serving process is disclosed, it will be recognized that different ad serving processes can utilize the ad filtering mechanisms described herein. Furthermore, while particular configurations have been disclosed in reference to Publisher web server and Publisher content source(s), it will be appreciated that other configurations could be used as well. For example, it is contemplated that the Publisher web server can serve the Publisher content from a content database coupled thereto. It will therefore be appreciated by those skilled in the art that yet other modifications could be made to the provided invention without deviating from its spirit and scope as claimed.

What is claimed is:

1. An apparatus used in serving advertisements over the world-wide-web, the apparatus comprising:
content monitoring means for automatically monitoring Publisher web content items that can be displayed alongside advertising content of one or more Advertiser Users; and
web-accessible data processing logic that cooperates with said content monitoring means to allow Advertiser Users to review web content items that can be displayed alongside Ads and specify ad filter data corresponding to a particular Ad and one or more web content items, the ad filter data controlling whether the particular Ad is excluded from accompanying the corresponding one or more web content items in conjunction with an ad serving process related thereto.

2. An apparatus according to claim 1, wherein:
the ad filter data corresponds to a particular Ad and a group of web content items and controls whether the particular Ad is excluded from accompanying the corresponding group of web content items in conjunction with the ad serving process related thereto.

3. An apparatus according to claim 1, wherein:
the ad filter data corresponds to a particular Ad and a particular web content item and controls whether the particular Ad is excluded from accompanying the corresponding particular web content item in conjunction with the ad serving process related thereto.

4. An apparatus according to claim 1, wherein:
the ad filter data includes a first part and a second part,
the first corresponding to a particular Ad and a group of web content items, the first part controlling whether the particular Ad is excluded from accompanying the corresponding group of web content items in conjunction with the ad serving process related thereto, and
the second part corresponding to a particular Ad and a particular web content item, the second part controlling whether the particular Ad is excluded from accompanying the corresponding particular web content item in conjunction with the ad serving process related thereto, and the second part overriding the control of the first part.

5. An apparatus according to claim 1, further comprising:
data storage means for storing said ad filter data.

6. An apparatus according to claim 5, further comprising:
query logic, operably coupled to said data storage means, for receiving a request supplied by an ad server engine that carries out said ad serving process, accessing said data storage means to retrieve ad filter data pertaining to said request, and returning data to said ad server engine, the returned data based on the retrieved ad filter data.

7. An apparatus according to claim 6, wherein:
the request supplied to the query logic includes an identifier for a user-requested Publisher web content item.

8. An apparatus according to claim 7, wherein:
the query logic accesses said data storage means to retrieve ad filter data corresponding to the identifier of the request.

9. An apparatus according to claim 7, wherein:
the request supplied to the query logic includes at least one subject descriptor pertaining to the user-requested Publisher web content item identified by the identifier.

10. An apparatus according to claim 9, wherein:
the query logic accesses said data storage means to retrieve ad filter data corresponding to the identifier and the at least one subject descriptor of the request.

11. An apparatus according to claim 6, wherein:
said web-accessible data processing logic includes logic for presenting to Advertising Users a graphical user interface that enables a particular Advertiser User to review a list of Campaigns of the particular Advertiser User and perform a variety of tasks related thereto.

12. An apparatus according to claim 11, wherein:
said web-accessible data processing logic includes logic for presenting a graphical user interface for real-time tracking and reporting of Campaigns as well as for individual Ads of the particular Advertising User.

13. An apparatus according to claim 11, wherein:
said web-accessible data processing logic includes logic for presenting a graphical user interface that enables a particular Advertiser User to create and manage Campaigns of the particular Advertising User.

14. An apparatus according to claim 13, wherein:
said web-accessible data processing logic includes logic for presenting a graphical user interface that enables the particular Advertiser User to create and managing one or more Outlets that are assigned to one or more Campaigns of the particular Advertiser User, wherein the Outlet specifies one or more Publisher web sites as well as one ore more Categories.

15. An apparatus according to claim 14, wherein:
said web-accessible data processing logic includes logic for presenting a graphical user interface that enables the particular Advertiser User to create and manage one or more Ad Rotations for the particular Advertiser User, wherein the Ad Rotation assigns one or more Ads of the Advertiser User to one or more Outlets.

16. An apparatus according to claim 15, wherein:
said query logic retrieves from a data repository information pertaining to one or more Ads that are assigned to an Ad Rotation whose Outlet corresponds to the request supplied thereto, and returns such information to the ad server engine for use in the ad serving process.

17. An apparatus according to claim 16, wherein:
the request supplied to the query logic includes an identifier and at least one subject descriptor pertaining to a user-requested Publisher web content item; and
the query logic retrieves from the data repository information pertaining to one or more Ads that are assigned to an Ad Rotation whose Outlet corresponds Outlet corresponds to the identifier and at least one subject descriptor of the request, and returns such information to the ad server engine for use in the ad serving process.

18. An apparatus according to claim 1, wherein:
said content monitoring means employs a web-based syndication means for automatically accessing Publisher web content items that can be displayed alongside advertising content of one or more Advertiser Users.

19. An apparatus according to claim 18, wherein:
the web-based syndication means employs a standardized syndication mechanism such as Real Simple Syndication.

20. An apparatus according to claim 1, wherein:
said Ads are selected from the group including a banner-type advertisement, a gateway-type advertisement, an interstitial-type advertisement, and a bumper-type advertisement.

21. A system for serving advertisements over the world-wide-web, the system comprising:
at least one ad server engine that carries out an ad serving process for serving Ads over the world-wide-web;
first data storage means for storing Publisher web content items;
content monitoring means, operably coupled to said first data storage means, for automatically monitoring Publisher web content items that can be displayed alongside advertising content of one or more Advertiser Users; and
web-accessible data processing logic that cooperates with said content monitoring means to allow Advertiser Users to review web content items that can be displayed alongside Ads and specify ad filter data corresponding to a particular Ad and one or more web content items, the ad filter data controlling whether the particular Ad is excluded from accompanying the corresponding one or more web content items in conjunction with the ad serving process carried out by the at least one ad server engine.

22. A system according to claim 21, wherein:
the ad filter data corresponds to a particular Ad and a group of web content items and controls whether the particular Ad is excluded from accompanying the corresponding group of web content items in conjunction with the ad serving process carried out by the at least one ad server engine.

23. A system according to claim 21, wherein:
the ad filter data corresponds to a particular Ad and a particular web content item and controls whether the particular Ad is excluded from accompanying the corresponding particular web content item in conjunction with the ad serving process carried out by the at least one ad server engine.

24. A system according to claim 21, wherein:
the ad filter data includes a first part and a second part,
the first corresponding to a particular Ad and a group of web content items, the first part controlling whether the particular Ad is excluded from accompanying the corresponding group of web content items in conjunction with the ad serving process carried out by the at least one ad server engine, and
the second part corresponding to a particular Ad and a particular web content item, the second part controlling whether the particular Ad is excluded from accompanying the corresponding particular web content item in conjunction with the ad serving process carried out by the at least one ad server engine, and the second part overriding the control of the first part.

25. A system according to claim 21, further comprising:
second data storage means for storing said ad filter data.

26. A system according to claim 25, further comprising:
query logic, operably coupled to said second data storage means, for receiving a request supplied by the at least one ad server engine, accessing said second data storage means to retrieve ad filter data pertaining to said request, and returning data to said ad server engine, the returned data based on the retrieved ad filter data.

27. A system according to claim 26, wherein:
the request supplied to the query logic includes an identifier for a user-requested Publisher web content item.

28. A system according to claim 27, wherein:
the query logic accesses said second data storage means to retrieve ad filter data corresponding to the identifier of the request.

29. A system according to claim 27, wherein:
the request supplied to the query logic includes at least one subject descriptor pertaining to the user-requested Publisher web content item identified by the identifier.

30. A system according to claim 29, wherein:
the query logic accesses said second data storage means to retrieve ad filter data corresponding to the identifier and the at least one subject descriptor of the request.

31. A system according to claim 26, wherein:
said web-accessible data processing logic includes logic for presenting to Advertising Users a graphical user interface that enables a particular Advertiser User to review a list of Campaigns of the particular Advertiser User and perform a variety of tasks related thereto.

32. A system according to claim 31, wherein:
said web-accessible data processing logic includes logic for presenting a graphical user interface for real-time tracking and reporting of Campaigns as well as for individual Ads of the particular Advertising User.

33. A system according to claim 31, wherein:
said web-accessible data processing logic includes logic for presenting a graphical user interface that enables a particular Advertiser User to create and manage Campaigns of the particular Advertising User.

34. A system according to claim 33, wherein:
said web-accessible data processing logic includes logic for presenting a graphical user interface that enables the particular Advertiser User to create and managing one or more Outlets that are assigned to one or more Campaigns of the particular Advertiser User, wherein the Outlet specifies one or more Publisher web sites as well as one ore more Categories.

35. A system according to claim 34, wherein:
said web-accessible data processing logic includes logic for presenting a graphical user interface that enables the particular Advertiser User to create and manage one or more Ad Rotations for the particular Advertiser User, wherein the Ad Rotation assigns one or more Ads of the Advertiser User to one or more Outlets.

36. A system according to claim 35, wherein:
said query logic retrieves from a data repository information pertaining to one or more Ads that are assigned to an Ad Rotation whose Outlet corresponds to the request supplied thereto, and returns such information to the ad server engine for use in the ad serving process.

37. A system according to claim 36, wherein:
the request supplied to the query logic includes an identifier and at least one subject descriptor pertaining to a user-requested Publisher web content item; and
the query logic retrieves from the data repository information pertaining to one or more Ads that are assigned to an Ad Rotation whose Outlet corresponds Outlet corresponds to the identifier and at least one subject descriptor of the request, and returns such information to the ad server engine for use in the ad serving process.

38. A system according to claim 21, wherein:
said content monitoring means employs a web-based syndication means for cooperating with said first data storage means to automatically access Publisher web content items that can be displayed alongside advertising content of one or more Advertiser Users.

39. A system according to claim 38, wherein:
the web-based syndication means employs a standardized syndication mechanism such as Real Simple Syndication.

40. A system according to claim 21, wherein:
said Ads are selected from the group including a banner-type advertisement, a gateway-type advertisement, an interstitial-type advertisement, and a bumper-type advertisement.

41. A method for serving advertisements over the world-wide-web, the method comprising:
storing Publisher web content items in first data storage means;
accessing said first data storage means to automatically monitor Publisher web content items that can be displayed alongside advertising content of one or more Advertiser Users; and
interacting with Advertiser Users to review web content items that can be displayed alongside Ads and specify ad filter data corresponding to a particular Ad and one or more web content items, the ad filter data controlling whether the particular Ad is excluded from accompanying the corresponding one or more web content items in conjunction with an ad serving process carried out by at least one ad server engine.

42. A method according to claim 41, wherein:
the ad filter data corresponds to a particular Ad and a group of web content items and controls whether the particular Ad is excluded from accompanying the corresponding group of web content items in conjunction with the ad serving process carried out by the at least one ad server engine.

43. A method according to claim 41, wherein:
the ad filter data corresponds to a particular Ad and a particular web content item and controls whether the particular Ad is excluded from accompanying the corresponding particular web content item in conjunction with the ad serving process carried out by the at least one ad server engine.

44. A method according to claim 41, wherein:
the ad filter data includes a first part and a second part,
the first corresponding to a particular Ad and a group of web content items, the first part controlling whether the particular Ad is excluded from accompanying the corresponding group of web content items in conjunction with the ad serving process carried out by the at least one ad server engine, and
the second part corresponding to a particular Ad and a particular web content item, the second part controlling whether the particular Ad is excluded from accompanying the corresponding particular web content item in conjunction with the ad serving process carried out by the at least one ad server engine, and the second part overriding the control of the first part.

45. A method according to claim 41, further comprising:
storing said ad filter data in a second data storage means.

46. A method according to claim 45, further comprising:
receiving a request supplied by the at least one ad server engine;
accessing said second data storage means to retrieve ad filter data pertaining to said request; and
returning data to said ad server engine, the returned data based on the retrieved ad filter data.

47. A method according to claim 46, wherein:
the request includes an identifier for a user-requested Publisher web content item.

48. A method according to claim 47, wherein:
the retrieved ad filter data corresponds to the identifier of the request.

49. A method according to claim 47, wherein:
the request includes at least one subject descriptor pertaining to the user-requested Publisher web content item identified by the identifier.

50. A method according to claim 49, wherein:
the retrieved ad filter data corresponding to the identifier and the at least one subject descriptor of the request.

51. A method according to claim 46, further comprising:
presenting to Advertising Users a graphical user interface that enables a particular Advertiser User to review a list of Campaigns of the particular Advertiser User and perform a variety of tasks related thereto.

52. A method according to claim 51, further comprising:
presenting a graphical user interface for real-time tracking and reporting of Campaigns as well as for individual Ads of the particular Advertising User.

53. A method according to claim 51, further comprising:
presenting a graphical user interface that enables a particular Advertiser User to create and manage Campaigns of the particular Advertising User.

54. A method according to claim 53, further comprising:
presenting a graphical user interface that enables the particular Advertiser User to create and managing one or more Outlets that are assigned to one or more Campaigns of the particular Advertiser User, wherein the Outlet specifies one or more Publisher web sites as well as one ore more Categories.

55. A method according to claim 54, further comprising:
presenting a graphical user interface that enables the particular Advertiser User to create and manage one or more Ad Rotations for the particular Advertiser User, wherein the Ad Rotation assigns one or more Ads of the Advertiser User to one or more Outlets.

56. A method according to claim 55, further comprising:
retrieving from a data repository information pertaining to one or more Ads that are assigned to an Ad Rotation whose Outlet corresponds to the request supplied thereto; and
returning such information to the ad server engine for use in the ad serving process.

57. A method according to claim 56, wherein:
the request includes an identifier and at least one subject descriptor pertaining to a user-requested Publisher web content item; and
the information retrieved from the data repository pertains to one or more Ads that are assigned to an Ad Rotation whose Outlet corresponds Outlet corresponds to the identifier and at least one subject descriptor of the request.

58. A method according to claim 41, further comprising:
employing a web-based syndication means for cooperating with said first data storage means to automatically access Publisher web content items that can be displayed alongside advertising content of one or more Advertiser Users.

59. A method according to claim 58, wherein:
the web-based syndication means employs a standardized syndication mechanism such as Real Simple Syndication.

60. A method according to claim 41, wherein:
said Ads are selected from the group including a banner-type advertisement, a gateway-type advertisement, an interstitial-type advertisement, and a bumper-type advertisement.

61. An apparatus for use in systems that serve advertisements over the world-wide-web, the apparatus comprising:
data storage means for storing location references associated with Ads;
logic, operable coupled to said data storage means, for automatically capturing at least one screen shot associated with a particular Ad, wherein a location reference for the particular Ad is retrieved from said data storage means for accessing the particular Ad.

62. An apparatus according to claim 61, wherein:
said data storage means stored metrics associated with said Ads, and
said logic analyzes at least one metric associated with a given Ad in order to initiate automatic capture of at least one screen shot for the given Ad.

63. An apparatus according to claim 62, wherein:
said logic checks whether said at least one metric associated with the given Ad exceeds a predetermined threshold before initiating automatic capture of at least one screen shot for the given Ad.

64. An apparatus according to claim 63, wherein:
said at least one metric is based on at least one of the following: the number of impressions for the given Ad, the number of days run for the given Ad, the number of hours run for the given Ad.
